(19) United States
(12) Patent Application Publication
(10) Pub. No.: US 2009/0021216 A1
(43) Pub. Date: Jan. 22, 2009

(54) Dual-Battery Charging And Discharging Method And Device And Portable Electronic Device Containing The Same

(76) Inventors: Malcolm Hills, Zhubei City (TW); David Lin, Zhubei City (TW)

Correspondence Address: LIN & ASSOCIATES INTELLECTUAL PROPERTY, INC., P.O. BOX 2339, SARATOGA, CA, 95070-0339, US

(21) Appl. No.: 11/778,646

(22) Filed: Jul. 17, 2007

(51) Int. Cl. H02J 7/00

(52) U.S. Cl. 320/134

(57) ABSTRACT

The device contains a first switch and a third switch for the charging and discharging of a main battery, and a second switch and a fourth switch for the charging and discharging of an auxiliary battery. The first switch or the second switch is turned on so as to connect and discharge the main battery or the auxiliary battery to a load circuit. The third switch or the fourth switch is turned on so as to charge the main battery or the auxiliary battery by an external power source. The present invention further provides a portable electronic device incorporating such a dual-battery charging and discharging method or device.

### BACKGROUND OF THE INVENTION

1. Field of the Invention

The present invention generally relates to charging and discharging methods and devices, and more particularly to a method and related device involving a main battery and an auxiliary device for charging and discharging.

2. The Related Arts

Due to the advancement of mobile communications and wireless networks, various hand-held or portable electronic devices such as cellular phones, personal digital assistants (PDAs), GPS (global positioning system) devices, etc. are gaining widespread popularity.

All these devices, when on the road, mainly rely on an internal rechargeable battery for power. As the battery has a limited capacity and if the battery is depleted, the device is of course out of service until the battery is charged.

How to keep these devices operational from their batteries for as long as possible therefore becomes an important issue to the manufacturers of these devices.

### BRIEF SUMMARY OF THE INVENTION

Accordingly, a novel dual-battery charging and discharging method and device, and a portable electronic device incorporating such a dual-battery charging and discharging method or device are provided.

The method controls the charging of a main battery and an auxiliary battery by an external power source and the discharging of the main and auxiliary batteries to a load circuit. The method provides a first switch and a third switch for the charging and discharging of the main battery; and a second switch and a fourth switch for the charging and discharging of the auxiliary battery. The method then detects the stored electricity of the main battery and the presence of the external power source to (1) turn on the first switch if there is no external power source and the main battery has enough electricity to discharge the main battery to the load circuit; (2) turn on the second switch if there is no external power source and the main battery does not have enough electricity to discharge the auxiliary battery to the load circuit; (3) turn on the third switch to charge the main battery by the external power source if the main battery is not fully charged; and (4) turn on the fourth switch to charge the auxiliary battery by the external power source if the main battery is fully charged.

The present invention further provides a device that contains a first switch and a third switch for the charging and discharging of the main battery; and a second switch and a fourth switch for the charging and discharging of the auxiliary battery.

The switches are then turned on and off in accordance with the foregoing method. The present invention further provides a portable electronic device that contains a main battery, an auxiliary battery, a first switch and a third switch for the charging and discharging of the main battery; and a second switch and a fourth switch for the charging and discharging of the auxiliary battery. The switches are then turned on and off in accordance with the foregoing method.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a dual-battery charging and discharging device according to a first embodiment of the present invention.

FIG. 2 is a circuit diagram showing the dual-battery charging and discharging device of FIG. 1.

FIG. 3 is a table describing the operations of the switches in accordance with the control signals V and A.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a dual-battery charging and discharging method and device, and a portable electronic device incorporating such a dual-battery charging and discharging method or device mainly containing a plurality of power source to achieve uninterrupted power provisioning.

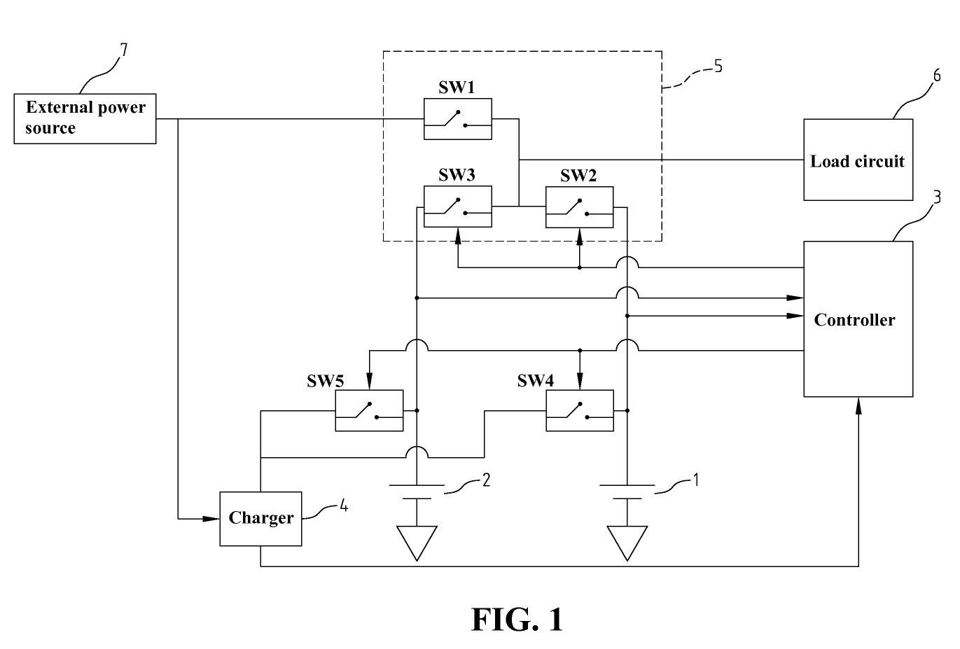

FIG. 1 is a schematic diagram showing a dual-battery charging and discharging device according to a first embodiment of the present invention. As illustrated, the device contains a main battery 1, an auxiliary battery 2, a controller 3, a charger 4, and a switch group 5. The switch group 5, on one hand, connects to a load circuit 6 and, on the other hand, connects to an external power source 7 and the main and auxiliary batteries 1 and 2. The switch group 5 determines whether the load circuit 6 is driven by the external power source 7 or by the main and auxiliary batteries 1 and 2.

When the load circuit 6 is driven by the main and auxiliary batteries 1 and 2, the switch group 5 can further determines it is the main battery 1 that drives the load circuit 6 if the main battery 1 has enough electricity, or it is the auxiliary battery 2 that drives the load circuit 6 if the main battery 1 does not have enough electricity.

To achieve these functions, in the present embodiment, the switch group 5 contains three switches SW1, SW2, and SW3, each either in an ON (i.e., close-circuited) or an OFF (i.e., open-circuited) state. In the following, turning on or off a switch means that the switch is set to the ON or OFF state. The main and auxiliary batteries 1 and 2 are series-connected to the load circuit 6 via the switches SW2 and SW3, respectively. The controller 3 connects to the main and auxiliary batteries 1 and 2 separately so as to monitor their respective stored electricity. Based on the monitor result, the controller 3 determines whether to turn on or off the switches SW2 and SW3, respectively. More specifically, if the main battery 1 has enough electricity, the controller 3 turns on the switch SW2 but turns off the switch SW3 so that the load circuit 6 is powered by the main battery 1. Alternatively, if the main battery 1 does not have enough electricity, the controller 3 turns off the switch SW3 but turns on the switch SW3 so that the load circuit 6 is powered by the auxiliary battery 2.

In addition, the external power source 7 is series-connected to the load circuit 6 via the switch SW1 and to the charger 4. The controller 3, on the other hand, connects to the charger 4 so as to detect the presence of the external power source 7.

When the external power source 7 is present, the voltage of the external power source 7 automatically turns on the switch SW1. In the mean time, as the controller 3 detects that the external power source 7 is present, it turns off the switches SW2 and SW3 so that the load circuit 6 draws electricity only from the external power source 7. When the external power source 7 is absent, the switch SW1 is automatically turned off. In the mean time, as the controller 3 detects that the external power source 7 is not present, it turns on one of the switches SW2 and SW3 as described earlier. According to the foregoing description, therefore, only one of the switches SW1, SW2, and SW3 is turned on and the load circuit 6 only draws electricity from only one of the external power source 7, the main battery 1, and the auxiliary battery 2 at any time.

As illustrated, the main and auxiliary batteries 1 and 2 are further series-connected to the charger 4 via the switches SW4 and SW5, respectively. Based on whether the external power source 7 is present, the controller 3 also determines whether to run on or off the switches SW4 and SW5.

If the external power source 7 is present, as described earlier, the circuits between the main and auxiliary batteries 1, 2 and the load circuit 6 are disrupted. In the mean time, the controller 3 turns on the switches SW4 and SW5 so that the charger 4 could charge the main and auxiliary batteries 1 and 2 using the external power source 7. If the external power source 7 is absent, the controller 3 turns off the switches SW4 and SW5 so that the charger 4 wouldn't become a load to the main and auxiliary batteries 1 and 2.

In a second embodiment of the present invention, when the external power source 7 is present, the controller 3 turns on the switch SW4 but turns off the switch SW5 so that only the main battery 1 is charged by the external power source 7 for a shorter charge time until the main battery 1 is fully charged. When the main battery 1 is fully charged, the controller 3 turns off the switch SW4 but turns on the switch SW5 so that only the auxiliary battery 2 is charged by the external power source 7, again, for a shorter charge time.

The capacities of the main and auxiliary batteries 1 and 2 are not limiting features of the present invention. However, in a third embodiment of the present invention, the main battery 1 is specifically chosen to have a larger capacity than that of the auxiliary batter 2 so that the load circuit 6 is mainly driven by the main battery for an extended period of time when the external power source 7 is absent.

In a fourth embodiment of the present invention, the main battery 1 is replaceable. More specifically, when the main battery 1 does not enough electricity, the controller 3 turns off the switch SW2 but turns on the switch SW3 so that the load circuit 6 is switched to be powered by the auxiliary battery 2. In the mean time, the depleted main battery 1 is replaced by a battery with sufficient electricity as the new main battery 1. When the new main battery 1 is installed, the controller 3 detects that the main battery 1 now has enough electricity and, therefore, turns on the switch SW2 but turns off the switch SW3 so that the load circuit 6 is restored to be powered by the main battery 1.

The priority of charge to the main and auxiliary batteries 1 and 2 is not a limiting feature of the present invention. However, in a fifth embodiment of the present invention, the controller 3 initially turns on the switch SW5 but turns off the switch SW4 so that the auxiliary battery 2 is charged first by the external power source 7 until the auxiliary battery 2 is fully charged. When the auxiliary battery 2 is fully charged, the controller 3 turns off the switch SW5 but turns on the switch SW4 so that the main battery 1 is charged next by the external power source 7.

In a sixth embodiment of the present invention, the charger 4 is able to detect whether the main or auxiliary batteries 1 or 2 is full and stop charging to the full main or auxiliary batteries 1 or 2 to prevent over-charging.

In a seventh embodiment of the present invention, when the load circuit 6 is powered by the main or auxiliary batteries 1 or 2, the controller 3 is able to monitor the remaining electricity of the main or auxiliary batteries 1 or 2. If the currently working battery has not enough electricity left but the other one does, the controller 3 automatically switch to use the other battery. If both the main and auxiliary batteries 1 and 2 do not have enough electricity, the controller 3 automatically disengages the main and auxiliary batteries 1 and 2. These functions are for the prevention of damage to the main and auxiliary batteries 1 and 2 resulted from deep discharging.

In an eighth embodiment of the present invention, the switches SW1, SW2, SW3, SW4, and SW5 are all controllable electronic switches such as field-effect transistors (FETs) and bipolar junction transistors (BJTs).

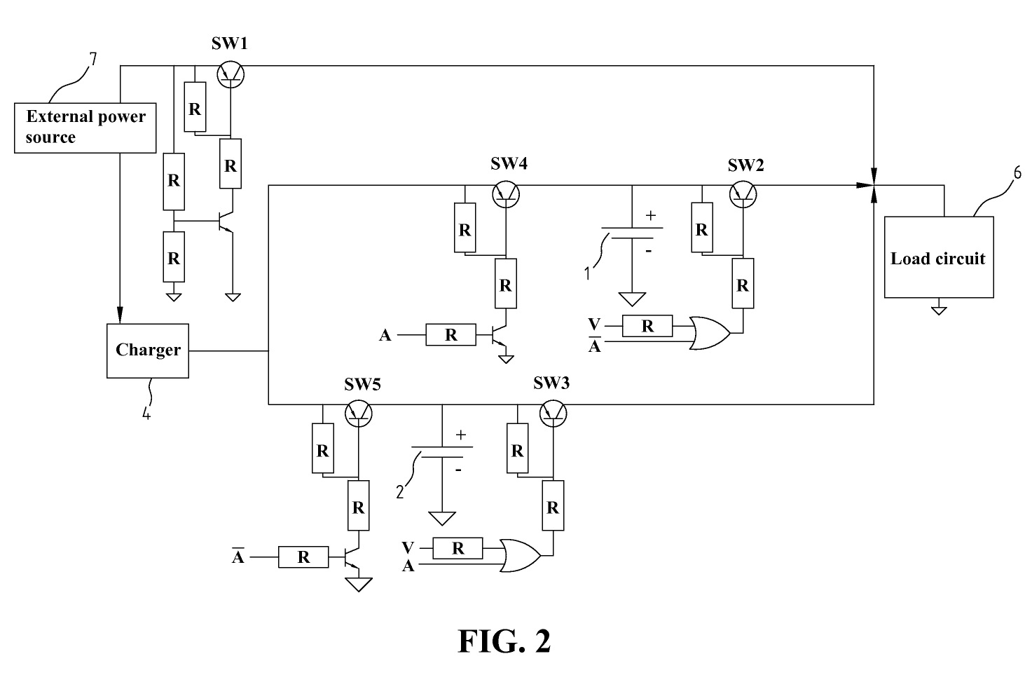

FIG. 2 is a circuit diagram showing the dual-battery charging and discharging device of FIG. 1. Please note that the controller 3 is not shown in the drawing. However, the control signals V and A issued from the controller 3 are shown to explain how the switches SW2, SW3, and SW4, and SW5 are turned on and off. R represents a resistor.

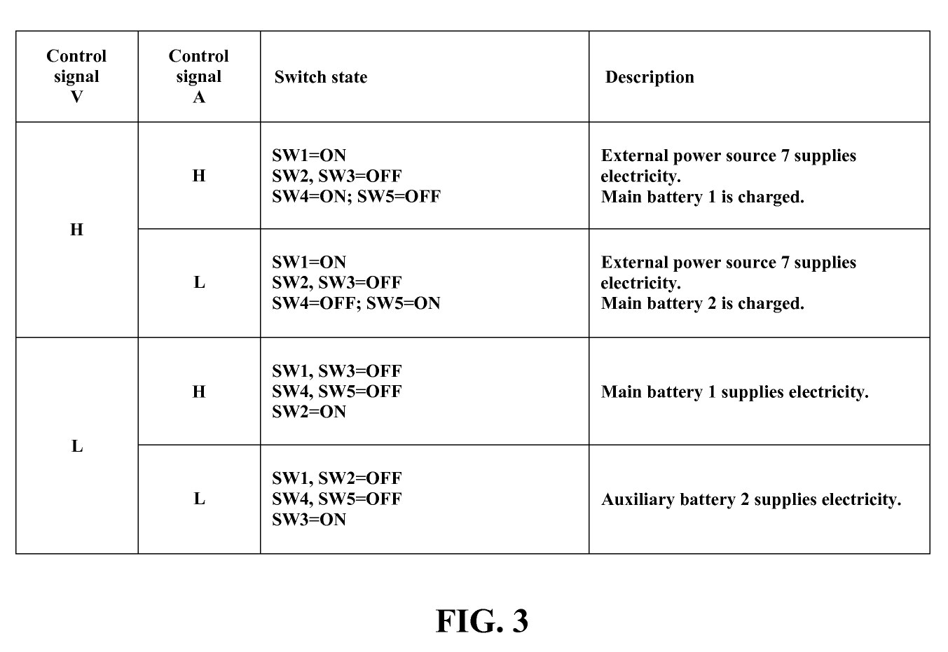

Please also refer to FIG. 3, which is a table describing the operations of the switches in accordance with the control signals V and A. As illustrated, When the controller 3 detects the presence of the external power source 7 via the charger 4, the control signal V is set to logic high (H); otherwise, the control signal V is set to logic low (L). When the control signal V is at logic high (H) (i.e., the external power source 7 is present), the control signal A is set to logic high (H) if the main battery 1 is not fully charged and the control signal A is set to logic low (L) if the main battery 1 is fully charged. On the other hand, when the control signal V is at logic low (L) (i.e., the external power source 7 is not present), the control signal A is set to logic high (H) if the main battery 1 has enough electricity and the control signal A is set to logic low (L) if the main battery 1 does not have enough electricity.

Accordingly, the switch SW2 is turned on when the control signal V is at logic low (L) and the control signal A is at logic high (H) (i.e., there is no external power source 7 and the main battery 1 has enough electricity). The load circuit 6 is therefore powered by the main battery 1. In the mean time, the switches SW3, SW4, and SW5 are all off. When the main battery 1 is depleted and does not have enough electricity, the controller 3 set the control signal A to logic low (L). The switch SW3 is turned on so that the load circuit 6 is switched to be powered by the auxiliary battery 2. In the mean time, the switches SW2, SW4, and SW5 are all off. Please note that, if there is no external power source 7, the switch SW1 is automatically off at all times.

On the other hand, if the external power source 7 is present, the switch SW1 is automatically on at all times. The switch SW4 is turned on when the control signal A is at logic high (H) (i.e., the main battery 1 is not fully charged). Therefore, the charger 4 directly charges the main battery 1 while the switches SW2, SW3, and SW5 are all off. When the main battery 1 is fully charged, the controller 3 set the control signal A to logic low (L). The switch SW5 is turned on so that the auxiliary battery 2 gets charged by the charger 4. In the mean time, the switches SW2, SW3, and SW4 are all off.

In the foregoing description, the control signal A decides that the main battery 1 has priority over the auxiliary batter 2. That is, the main battery 1 is used first to drive the load circuit 6 when there is no external power source 7 and the main battery 1 get charged first if the external power source 7 is present. In an alternative embodiment, the priority can be reversed by having the control signal A set to the logic high (H) if the auxiliary battery 2 is not fully charge when the control signal V is at logic high (H), and if the auxiliary battery 2 has enough electricity when the control signal V is at logic low (L).

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for controlling the charging a main battery and an auxiliary battery by an external power source and discharging said main battery and said auxiliary battery to a load circuit, comprising the steps of:
providing a first switch and a third switch for the charging and discharging of said main battery;
providing a second switch and a fourth switch for the charging and discharging of said auxiliary battery;
detecting the stored electricity of said main battery and setting a first control signal;
detecting the presence of said external power source and setting a second control signal;
turning on said first switch when said second control signal is at logic low and said first control signal is at logic high so as to connect and discharge said main battery to said load circuit;
turning on said second switch when said second control signal is at logic low and said first control signal is at logic low so as to connect and discharge said auxiliary battery to said load circuit;
turning on said third switch when said first control signal is at logic high so as to charge said main battery by said external power source; and
turning on said fourth switch when said first control signal is at logic low so as to charge said auxiliary battery by said external power source.

2. The method according to claim 1, further comprising the step of:
providing a charger for charging said main and secondary batteries by said external power source.

3. The method according to claim 2, wherein said charger is capable of charging said main and auxiliary batteries only when said external power source is present.

4. The method according to claim 1, wherein said second control signal is set to logic high when said external power source is present; and said second control signal is set to logic low when said external power source is not present.

5. The method according to claim 4, wherein, when said second control signal is at logic high, said first control signal is set to logic high if said main battery is not fully charged and said first control is set to logic low if said main battery is fully charged.

6. The method according to claim 4, wherein, when said second control signal is at logic low, said first control signal is set to logic high if said main battery has enough electricity and said first control is set to logic low if said main battery does not have enough electricity.

7. A device for controlling the charging a main battery and an auxiliary battery by an external power source and discharging said main battery and said auxiliary battery to a load circuit, comprising:
a first switch and a third switch for the charging and discharging of said main battery, said first switch series-connected between said load circuit and said main battery, said third switch series-connected between said external power source and said main battery;
a second switch and a fourth switch for the charging and discharging of said auxiliary battery, said second switch series-connected between said load circuit and said auxiliary battery, said fourth switch series-connected between said external power source and said auxiliary battery.
wherein
said first switch is turned on when a second control signal is at logic low and a first control signal is at logic high so as to connect and discharge said main battery to said load circuit;
said second switch is turned on when said second control signal is at logic low and said first control signal is at logic low so as to connect and discharge said auxiliary battery to said load circuit;
said third switch is turned on when said first control signal is at logic high so as to charge said main battery by said external power source; and
said fourth switch is turned on when said first control signal is at logic low so as to charge said auxiliary battery by said external power source.

8. The device according to claim 7, further comprising a controller issuing said first and second control signals.

9. The device according to claim 7, further comprising a charger for charging said main and auxiliary batteries.

10. The device according to claim 9, wherein said charger is series-connected between said external power source and said third switch.

11. The device according to claim 9, wherein said charger is series-connected between said external power source and said fourth switch.

12. The device according to claim 9, wherein said charger is capable of charging said main and auxiliary batteries only when said external power source is present.

13. The device according to claim 7, wherein said first, second, third, and, fourth switches are controllable electronic switches.

14. The device according to claim 7, wherein at least one of said first, second, third, and, fourth switches is one of a FET transistors and a BJT transistor.

15. A portable electronic device, comprising:
a main battery and an auxiliary battery:
a first switch and a third switch for the charging and discharging of said main battery, said first switch series-connected between a load circuit and said main battery, said third switch series-connected between an external power source and said main battery;
a second switch and a fourth switch for the charging and discharging of said auxiliary battery, said second switch series-connected between said load circuit and said auxiliary battery, said fourth switch series-connected between said external power source and said auxiliary battery.
wherein
said first switch is turned on when a second control signal is at logic low and a first control signal is at logic high so as to connect and discharge said main battery to said load circuit;
said second switch is turned on when said second control signal is at logic low and said first control signal is at logic low so as to connect and discharge said auxiliary battery to said load circuit;
said third switch is turned on when said first control signal is at logic high so as to charge said main battery by said external power source; and
said fourth switch is turned on when said first control signal is at logic low so as to charge said auxiliary battery by said external power source.

16. The device according to claim 15, further comprising a controller issuing said first and second control signals.

17. The device according to claim 15, further comprising a charger for charging said main and auxiliary batteries.

18. The device according to claim 17, wherein said charger is series-connected between said external power source and said third switch.

19. The device according to claim 17, wherein said charger is series-connected between said external power source and said fourth switch.

20. The device according to claim 17, wherein said charger is capable of charging said main and auxiliary batteries only when said external power source is present.

21. The device according to claim 15, wherein said first, second, third, and, fourth switches are controllable electronic switches.

22. The device according to claim 15, wherein at least one of said first, second, third, and, fourth switches is one of a FET transistors and a BJT transistor.
